(19) United States
(12) Patent Application Publication
(10) Pub. No.: US 2016/0145114 A1
(43) Pub. Date: May 26, 2016

(54) REACTION TUBE AND METHOD FOR PRODUCING HYDROGEN CYANIDE

(71) Applicants: Bernd GLÖCKLER, Rodenbach (DE); Martin STEFFAN, Singapore (SG); Martin STEURENTHALER, Singapore (SG); Thomas MÜLLER, Altenstadt (DE); Steffen KRILL, Mühltal (DE); Martin KÖRFER, Kahl (DE); EVONIK DEGUSSA GMBH, Essen (DE)

(72) Inventors: Bernd Glockler, Rodenbach (DE); Martin Steffan, Singapore (SG); Martin Steurenthaler, Singapore (SG); Thomas Müller, Altenstadt (DE); Nicolas Rigot, Frankfurt (DE); Steffen Krill, Mühltal (DE); Martin Körfer, Kahl (DE)

(73) Assignee: Evonik Degussa GmbH, Essen (DE)

(21) Appl. No.: 14/896,719

(22) PCT Filed: May 21, 2014
(86) PCT No.: PCT/EP2014/060389

§ 371 Date: Dec. 8, 2015

(30) Foreign Application Priority Data
Jun. 11, 2013 (EP) 13171415.6

(51) Int. Cl. C01C 3/02; B01J 19/00; B01J 19/24

(52) U.S. Cl. CPC C01C 3/0229; B01J 19/2415; B01J 19/006; B01J 2219/00777; B01J 2219/24

(57) ABSTRACT

The reaction tube comprises a cylindrical ceramic tube and a catalyst comprising platinum applied to the inner surface of the tube, wherein the reaction tube has fins on the inner surface which run in the longitudinal direction of the tube, extend into the interior space of the reaction tube and are coated with catalyst. The reaction tube is suitable for preparing hydrogen cyanide by reacting ammonia and at least one aliphatic hydrocarbon having 1 to 4 carbon atoms at a temperature of 1000 to 1400° C.

The invention relates to a reaction tube for preparing hydrogen cyanide, and also to a method for preparing hydrogen cyanide using this reaction tube.

The BMA process for preparing hydrogen cyanide from ammonia and an aliphatic hydrocarbon having 1 to 4 carbon atoms is carried out at temperatures in the range of 1000° C. to 1400° C. Since the reaction is endothermic, heat must be supplied to the reaction mixture during the process. On an industrial scale, the BMA process is carried out in externally heated reaction tubes, which have been coated on the tube interior with a catalyst comprising platinum and through which the gaseous reaction mixture is passed. The space-time yield in these industrial reactors is determined by the geometrical surface area of the reaction tube and the active surface area of the platinum-containing catalyst limited thereby.

For reaction tubes used in the BMA process, approaches to increase the surface area/volume ratios of the surface coated with the catalyst or to increase the space-time yield by changing the flow conditions in the reaction tube are known from the prior art.

DE 29 36 844 A1 proposes producing a turbulent flow in the reaction tube by internals or random packings, which may be wholly or partially coated with catalyst, in order to improve the space-time yield and the yield of hydrogen cyanide.

WO 90/13405 discloses reaction tubes for the BMA process which have periodic changes in the cross section of the reaction tube from a circular cross section to an elliptical cross section.

DE 41 28 201 describes reaction tubes for the BMA process having internals in the form of coils, which increase the turbulent proportion of the flow of the reaction gases.

However, a common aspect of all these reaction tubes is that soot contamination occurs to an enhanced degree on the inner surfaces of the reaction tube during the preparation of hydrogen cyanide. The soot formed by the decomposition of the aliphatic hydrocarbons used for the preparation of hydrogen cyanide is deposited on the catalyst comprising platinum and thereby inhibits the reaction forming hydrogen cyanide. For this reason, frequent measures must be taken for the removal of soot deposits, for which the preparation of hydrogen cyanide has to be interrupted.

Reaction tubes with tubular or rod-shaped internals arranged longitudinally inside the reaction tube are known from DE 1 078 554 and WO 2006/050781. Although the space-time yield and the yield of hydrogen cyanide can be improved with these internals, these internals require a relativity complex installation of the reaction tubes in the reactor with alignment of the internals in the reaction tube.

For this reason, there still exists a need for reaction tubes for the preparation of hydrogen cyanide with which an improved space-time yield and a higher yield of hydrogen cyanide can be achieved, in comparison to the cylindrical tubes used on an industrial scale, without additional complexity in the manufacture and the installation of the reaction tubes in the reactor being required.

The invention relates to a reaction tube for preparing hydrogen cyanide comprising a cylindrical ceramic tube and a catalyst comprising platinum applied to the inner surface of the tube, wherein the reaction tube has fins on the inner surface which run in the longitudinal direction of the tube, extend into the interior space of the reaction tube and are coated with catalyst.

The invention also relates to the use of the reaction tube for preparing hydrogen cyanide, and to a method for preparing hydrogen cyanide by reacting ammonia and at least one aliphatic hydrocarbon having 1 to 4 carbon atoms in the presence of a catalyst comprising platinum at a temperature of 1000 to 1400° C. in the reaction tube according to the invention.

The reaction tube according to the invention may be manufactured in the same manner as the known cylindrical reaction tubes by extruding a plastic ceramic material to give a tubular green body, drying of the green body and subsequent calcination. During the extrusion, an annular gap having additional openings corresponding to the fins has only to be used in place of a circular annular gap. The application of the catalyst comprising platinum onto the tube inner surface and the fins, and the installation of the reaction tube in the reactor for preparing hydrogen cyanide, may be conducted in the same manner as for known cylindrical reaction tubes.

The reaction tube according to the invention preferably has 2 to 6 fins, particularly preferably 3 or 4 fins and most preferably 4 fins, on the inner surface. The fins preferably extend into the interior space of the reaction tube by more than 0.1 times the inner diameter of the tube. In a particularly preferred embodiment, the fins abut one another in the centre of the reaction tube and divide the interior space of the reaction tube into a plurality of chambers separated from one another.

The fins on the inner surface of the reaction tube preferably have a mean thickness which is 0.25 to 2.5 times the mean thickness of the wall of the reaction tube. The fins on the inner surface of the reaction tube particularly preferably have a uniform thickness, and the fins and the wall of the reaction tube particularly preferably have essentially the same thickness.

The reaction tube according to the invention has a cylindrical shape, wherein the inner diameter of the tube is preferably 10 to 50 mm and particularly preferably 15 to 30 mm. The length of the reaction tube is preferably in the range of 1000 to 5000 mm and particularly preferably in the range of 1500 to 2500 mm.

The reaction tube according to the invention is preferably composed of a gas-tight sintered ceramic and particularly preferably gas-tight sintered aluminium oxide or silicon carbide.

The reaction tube according to the invention is entirely or partially coated on the inner side and on the fins with a catalyst comprising platinum. Preferably more than 80% of the geometric surface area of the inner side of the reaction tube and the fins are coated with the catalyst comprising platinum. All catalysts known for the BMA process for preparing hydrogen cyanide may be used as catalysts comprising platinum. The catalysts having a reduced tendency for sooting known from WO 2004/076351 are preferably used. The catalysts comprising platinum may be applied to the inner side of the reaction tube by all known methods for applying such catalysts on support materials.

The methods described in EP-A 0 299 175, EP-A 0 407 809 and EP-A 0 803 430 for applying the catalyst comprising platinum to the inner side of the reaction tube are preferably used.

The reaction tube according to the invention can be used for preparing hydrogen cyanide by the so-called BMA process.

In the method according to the invention for preparing hydrogen cyanide, ammonia and at least one aliphatic hydrocarbon having 1 to 4 carbon atoms are reacted in the presence of a catalyst comprising platinum at a temperature of 1000 to 1400° C. in at least one reaction tube according to the invention. For this purpose, a gas mixture comprising ammonia and at least one aliphatic hydrocarbon having 1 to 4 carbon atoms is passed through the reaction tube according to the invention and the reaction tube is maintained at a temperature of 1000° C. to 1400° C. by external heating. The hydrocarbons are preferably composed of at least 90 vol % methane. The gas mixture used for preparing hydrogen cyanide preferably comprises ammonia in stoichiometric excess. When using methane as hydrocarbon, a molar ratio of ammonia to methane in the range of 1.01:1 to 1.30:1 is preferably used. The flow rate of the gas mixture through the reaction tube is preferably selected such that an essentially laminar flow is formed.

The figures show cross sections of reaction tubes known from the prior art and reaction tubes according to the invention.

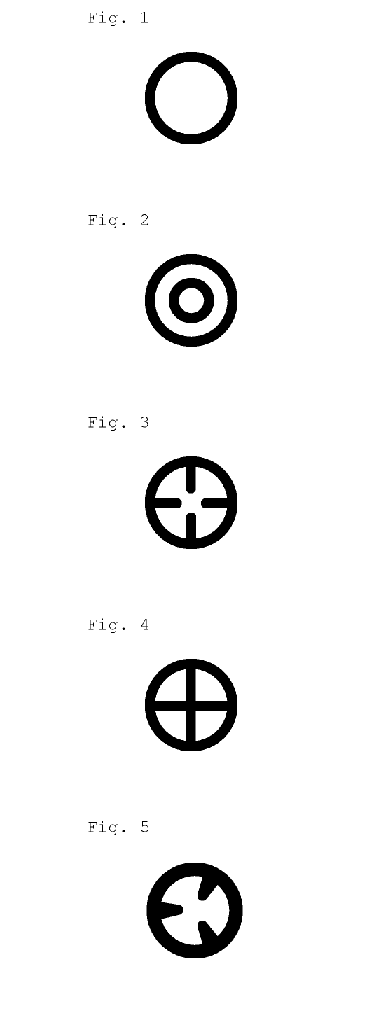

FIG. 1 shows the cross section through a cylindrical reaction tube known from the prior art.

FIG. 2 shows the cross section through a reaction tube known from the prior art having a tubular insert in the centre of the tube. For preparing hydrogen cyanide, the gas mixture is passed through the gap between the two tubes.

FIG. 3 shows the cross section through a reaction tube according to the invention with 4 fins, which do not extend to the centre of the reaction tube.

FIG. 4 shows the cross section through a reaction tube according to the invention with 4 fins, which extend to the centre of the reaction tube and divide the interior space of the reaction tube into 4 chambers separated from one another.

FIG. 5 shows the cross section through a reaction tube according to the invention with 3 fins, which do not extend to the centre of the reaction tube and the thickness of which decreases with increasing distance from the inner surface of the reaction tube.

The following examples demonstrate the advantageous effect of a reaction tube according to the invention in the preparation of hydrogen cyanide from ammonia and methane in comparison to a cylindrical reaction tube and to a reaction tube having a tubular insert.

### EXAMPLES

### Example 1 (Comparative Example)

A cylindrical reaction tube composed of sintered aluminium oxide of length 2100 mm and internal diameter 17 mm was coated with a platinum-containing catalyst and formed as described in example 6 of EP 0 407 809 A. A gas mixture composed of 44 mol/h ammonia and 40 mol/h methane was then passed from below through the reaction tube at 1280° C. The exiting product gas was analyzed; the yield of hydrogen cyanide was 79.9% based on ammonia (88.8% based on methane).

### Example 2 (Comparative Example)

Example 1 was repeated, however a tube composed of sintered aluminium oxide of length 1200 m and external diameter 6 mm, coated externally with catalyst, was arranged centrically in the reaction tube and the gas mixture was passed through the annular gap between the tubes. The yield of hydrogen cyanide was 84.4% based on ammonia (93.3% based on methane).

### Example 3

Example 1 was repeated, however a reaction tube was used having a cross section corresponding to FIG. 3, which had four fins with a mean thickness of 3 mm, running in the longitudinal direction of the tube and each extending 4.5 mm into the interior space of the reaction tube. The yield of hydrogen cyanide was 84.0% based on ammonia (92.5% based on methane).

### Example 4

Example 1 was repeated, however a reaction tube was used having a cross section corresponding to FIG. 4, which had four fins running in the longitudinal direction of the tube and abutting one another in the middle of the reaction tube, which divided the reaction space into 4 separate chambers and whose thickness corresponded to the thickness of the wall of the reaction tube. The yield of hydrogen cyanide was 90.0% based on ammonia (99.0% based on methane).

### Example 5

Example 1 was repeated, however a reaction tube was used having a cross section corresponding to FIG. 5, which had three fins running in the longitudinal direction of the tube and each extending 4.75 mm into the interior space of the reaction tube, whose thickness of 3 mm on the inner surface of the reaction tube decreased to 2 mm towards the interior of the reaction tube. The yield of hydrogen cyanide was 84.9% based on ammonia (93.7% based on methane).

1-10. (canceled)

11. A reaction tube for preparing hydrogen cyanide comprising a cylindrical ceramic tube and a catalyst comprising platinum applied to the inner surface of the tube, wherein the reaction tube has fins on the inner surface which run in the longitudinal direction of the tube, extend into the interior space of the reaction tube and are coated with catalyst.

12. The reaction tube of claim 11, wherein the reaction tube has 2 to 6 fins.

13. The reaction tube of claim 11, wherein the reaction tube has 3 or 4 fins.

14. The reaction tube of claim 11, wherein the fins extend into the interior space of the reaction tube by more than 0.1 times the inner diameter of the tube.

15. The reaction tube of claim 11, wherein the fins abut one another in the centre of the reaction tube and divide the interior space of the reaction tube into a plurality of chambers separated from one another.

16. The reaction tube of claim 11, wherein the fins have a mean thickness which is 0.25 to 2.5 times the mean thickness of the wall of the reaction tube.

17. The reaction tube of claim 11, wherein the thickness of the fins decreases with increasing distance from the inner surface of the reaction tube.

18. The reaction tube of claim 11, wherein the reaction tube and the fins are composed of gas-tight sintered aluminium oxide or silicon carbide.

19. A method for preparing hydrogen cyanide by reacting ammonia and at least one aliphatic hydrocarbon having 1 to 4 carbon atoms in the presence of a catalyst comprising platinum at a temperature of 1000 to 1400° C., wherein:
a) the reaction is carried out in at least one reaction tube comprising a cylindrical ceramic tube and a catalyst comprising platinum applied to the inner surface of the tube; and
b) the reaction tube has fins on the inner surface which run in the longitudinal direction of the tube, extend into the interior space of the reaction tube and are coated with catalyst.

20. The method of claim 19, wherein the hydrocarbons are composed of at least 90 vol % of methane.

21. The method of claim 19, wherein the reaction tube has 2 to 6 fins.

22. The method of claim 19, wherein the reaction tube has 3 or 4 fins.

23. The method of claim 19, wherein said fins extend into the interior space of the reaction tube by more than 0.1 times the inner diameter of the tube.

24. The method of claim 19, wherein said fins abut one another in the centre of the reaction tube and divide the interior space of the reaction tube into a plurality of chambers separated from one another.

25. The method of claim 24, wherein the hydrocarbons are composed of at least 90 vol % of methane.

26. The method of claim 19, wherein said fins have a mean thickness which is 0.25 to 2.5 times the mean thickness of the wall of the reaction tube.

27. The method of claim 19, wherein the thickness of the fins decreases with increasing distance from the inner surface of the reaction tube.

28. The method of claim 19, wherein the reaction tube and the fins are composed of gas-tight sintered aluminium oxide or silicon carbide.

29. The method of claim 27, wherein the hydrocarbons are composed of at least 90 vol % of methane.

30. The method of claim 19, wherein:
a) the reaction tube has 2 to 6 fins.
b) the fins extend into the interior space of the reaction tube by more than 0.1 times the inner diameter of the tube.
c) the fins abut one another in the centre of the reaction tube and divide the interior space of the reaction tube into a plurality of chambers separated from one another; and
d) the hydrocarbons are composed of at least 90 vol % of methane;
